(19) United States
(12) Patent Application Publication
(10) Pub. No.: US 2026/0279069 A1
(43) Pub. Date: Sep. 17, 2026

(54) SYSTEM AND METHOD FOR DETERMINING CONSTITUTION OF DETECTED VEHICLE AS AUXILIARY OR SEPARATE VEHICLE

(71) Applicant: Transportation IP Holdings, LLC, Norwalk, CT (US)

(72) Inventor: Amit Saxena, Marion, IA (US)

(73) Assignee: Transportation IP Holdings, LLC, Norwalk, CT (US)

(21) Appl. No.: 19/079,869

(22) Filed: Mar. 14, 2025

(51) Int. Cl. G06V 20/58; G08G 9/02

(52) U.S. Cl. CPC G06V 20/58; G08G 9/02; G06V 2201/08

(57) ABSTRACT

A system and a method are recited. One or more rear images within a field of view of an image capturing device are captured. The image capturing device face an environment behind a vehicle system. The environment has a route traveled by the vehicle system. Based at least in part on the one or more rear image and one or more reference images, a vehicle on the route behind the vehicle system is detected, and whether the detected vehicle constitutes an auxiliary vehicle or a separate vehicle is determined.

### BACKGROUND

### Technical Field

The disclosure pertains to a system and a method for detecting vehicles, with a particular focus on determining constitution of a detected vehicle as an auxiliary vehicle or a separate vehicle.

### Discussion of Art

A helper locomotive is allowed to be attached to and then detached from a train without connection with a brake line of the train, and the attachment of the helper locomotive to the train can be performed during the train is still moving. However, an initial train length and an end train telemetry are no longer applicable due to the attachment of the helper locomotive, and a protection system applied to the train is unable to be also applied to the helper locomotive as a length of the helper locomotive is not combined with the initial train length. Furthermore, the presence of the helper locomotive is hard to be detected, and whether the helper locomotive constitutes a permitted helper locomotive is therefore hard to be determined.

### BRIEF DESCRIPTION

In one embodiment, a system includes a control circuit. The control circuit is configured to capture one or more rear images within a field of view of an image capturing device. The image capturing device faces an environment behind a vehicle system. The environment includes a route traveled by the vehicle system. The control circuit is further configured to, based at least in part on the one or more rear image and one or more reference images, detect a vehicle on the route behind the vehicle system and determine whether the detected vehicle constitutes an auxiliary vehicle or a separate vehicle.

In one embodiment, a method includes capturing one or more rear images within a field of view of an image capturing device. The image capturing device faces an environment behind a vehicle system. The environment includes a route traveled by the vehicle system. The method further includes, based at least in part on the one or more rear images and one or more reference images, detecting a vehicle on the route behind the vehicle system and determining whether the detected vehicle constitutes an auxiliary vehicle or a separate vehicle.

In one embodiment, a system includes a control circuit. The control circuit is configured to capture one or more images within a field of view of an image capturing device. The image capturing device targets an environment recently passed by a vehicle system. The environment includes a route traveled by the vehicle system. The control circuit is further configured to, based at least in part on the one or more images and one or more reference images, detect a vehicle on the route behind the vehicle system and determine whether the detected vehicle constitutes an auxiliary vehicle of the vehicle system or a separate vehicle.

### BRIEF DESCRIPTION OF THE DRAWINGS

FIG. 1 illustrates a schematic diagram of a system having an image capturing device facing an environment behind a vehicle system traveling a route according to one embodiment.

FIG. 2 illustrates a schematic diagram of a system detecting a vehicle on a route behind and traveled by a vehicle system according to one embodiment.

FIG. 3 illustrates a schematic diagram of a field of view of an image capturing device of a system while the image capturing device faces an environment behind a vehicle system according to one embodiment.

FIG. 4 illustrates a schematic diagram of a system detecting an auxiliary vehicle on a route behind and traveled by a vehicle system and for attaching to the vehicle system according to one embodiment.

FIG. 5 illustrates a schematic diagram of a system according to one embodiment.

FIG. 6 illustrates a schematic diagram of a vehicle system according to one embodiment.

FIG. 7 illustrates a schematic diagram of a system according to one embodiment.

FIG. 8 illustrates a schematic diagram of a control circuit located at a control center according to one embodiment.

FIG. 9 illustrates a schematic diagram of a vehicle protection system coupled with a detected vehicle in addition to a vehicle system according to one embodiment.

FIG. 10 illustrates a flow chart of a method according to one embodiment.

### DETAILED DESCRIPTION

Reference will now be made in detail to the embodiments consistent with the invention, examples of which are illustrated in the accompanying drawings. Wherever possible, the same reference numerals used throughout the drawings refer to the same or like parts.

Exemplary embodiments of the invention solve the problems in the art by providing a system and a method and for determining whether a detected vehicle constitutes an auxiliary vehicle or a separate vehicle, or, for determining which one of the auxiliary vehicle and the separate vehicle the detected vehicle constitutes.

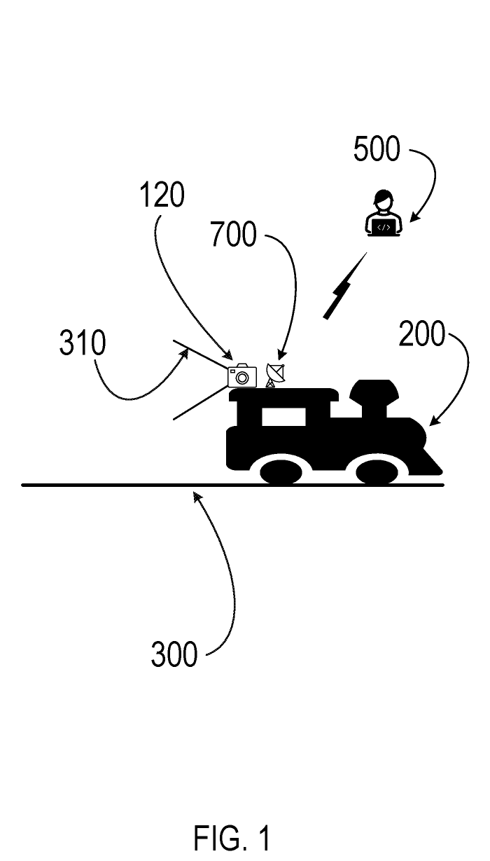

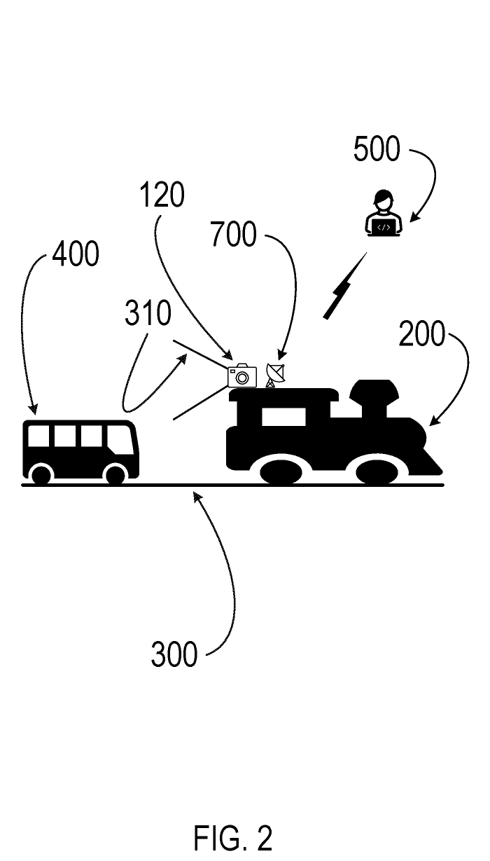

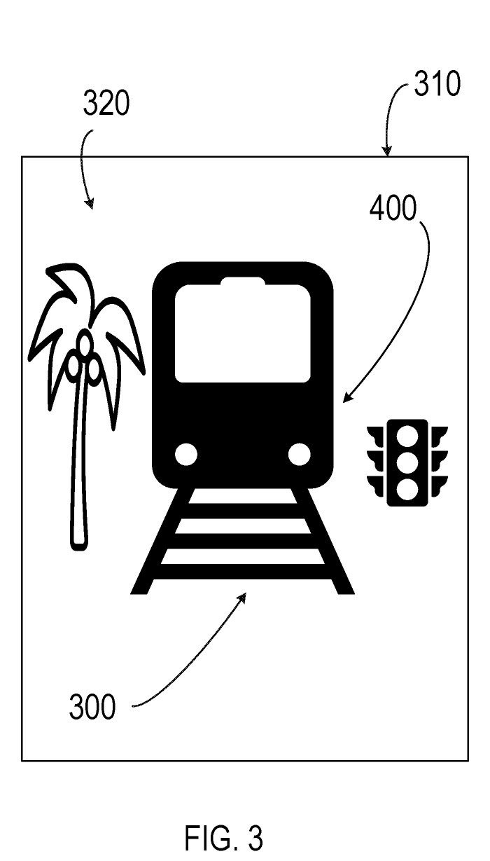

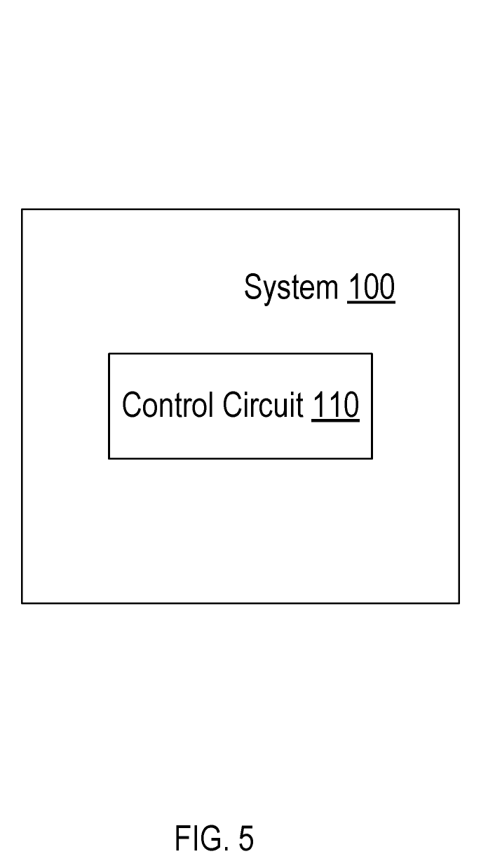

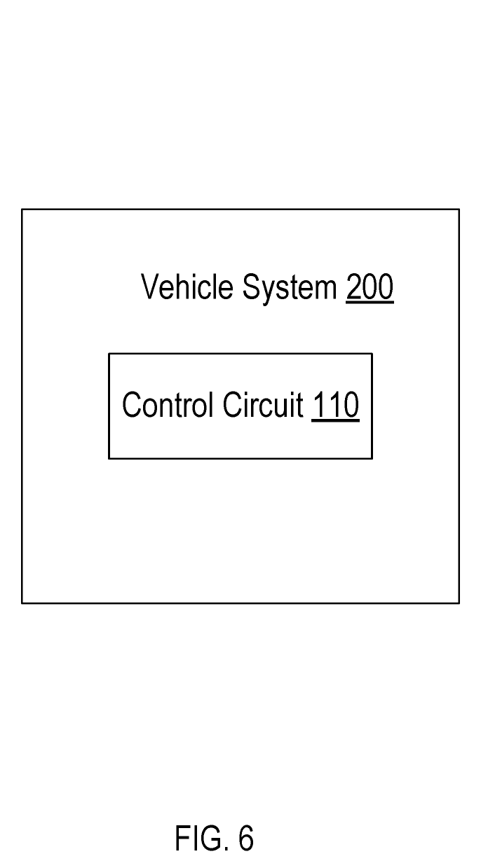

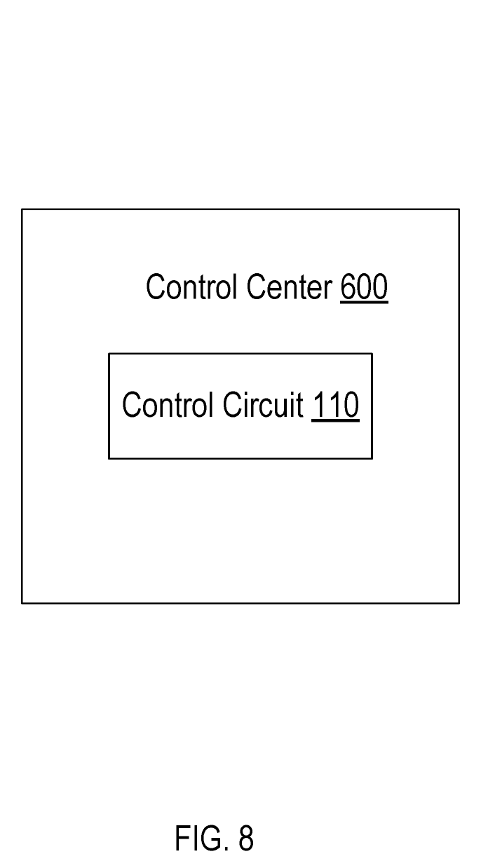

In one embodiment, a system 100, as shown in FIG. 5., includes a control circuit 110. The control circuit captures one or more rear images within a field of view 310 of an image capturing device 120, as shown in FIGS. 1-4. The image capturing device may capture rear images periodically, or randomly, or at a configurable frequency, or in real-time. The image capturing device faces an environment 320 behind a vehicle system 200, as shown in FIGS. 1-4, and 6. The environment includes a route 300 traveled by the vehicle system, as shown in FIGS. 1-4. The control circuit, based at least in part on the one or more rear image and one or more reference images, detects a presence, or a characteristic, of a vehicle 400, as shown in FIGS. 2-4, on the route behind the vehicle system, and determines whether the detected vehicle constitutes an auxiliary vehicle or a separate vehicle. The control circuit may be operated by an operator 500, as shown in FIGS. 1-2 and 4, whether a personnel or a computer, who may be located onboard the vehicle system, or at a remote control center 600, as shown in FIG. 8. The control circuit may be located onboard the vehicle system, as shown in FIG. 6, or at the remote control center.

A storage device stores the one or more reference images, while the control circuit retrieves the one or more reference images from the storage device. The auxiliary vehicle, also termed as “helper vehicle,” is used to supply additional power to the vehicle system upon attachment to the vehicle system, while the separate vehicle is not used to supply additional power to the vehicle system as it is not allowed to be attached to the vehicle system. The auxiliary vehicle may be attached to the vehicle system when the vehicle system may be moving or idle. In addition, the auxiliary vehicle is or is not coupled with a brake system of the vehicle system upon attachment to the vehicle system.

In one embodiment, in the system, the image capturing device is mounted on a rear end of the vehicle system, as shown in FIGS. 1-2 and 4. The rear end of the vehicle system is a rear side, portion, or section of the vehicle system.

In one embodiment, in the system, at least one of the one or more reference images depicts the route without a vehicle. The control circuit further detects the vehicle on the route by comparing the at least one of the one or more reference images that depict the route without a vehicle to the one or more rear images. The control circuit detects the vehicle on the route by further determining, based at least in part on the comparison, that differences between the at least one of the one or more reference images and the one or more rear images indicate the presence of the vehicle on the route behind the vehicle system. The differences between the at least one reference image and the one or more rear images are made by determining that the one or more rear images depicts at least one portion of the vehicle on the route compared with a corresponding route without any vehicle depicted in the at least one reference image, comparing the at least one portion of the vehicle with a set percentage of the vehicle, and then determining that the at least one portion of the vehicle is equivalent to or larger than the set percentage of the vehicle which indicates the presence of the vehicle on the route behind the vehicle system. On the other hand, if the at least one portion of the vehicle is smaller than the set percentage of the vehicle, it indicates absence of the vehicle on the route behind the vehicle system. Additionally, or alternatively, the differences between the at least one reference image and the one or more rear images are made by determining that the one or more rear images depicts at least one portion of the vehicle occupying the route and an unoccupied section of the route compared with a corresponding route without any vehicle depicted in the at least one reference image, comparing the unoccupied section of the route with the corresponding route without any vehicle, and then determining that the unoccupied section of the route is smaller than a set percentage of the corresponding route without any vehicle which indicates the presence of the vehicle on the route behind the vehicle system. On the other hand, if the unoccupied section of the route is equivalent to or larger than the set percentage of the corresponding route without any vehicle, it indicates absence of the vehicle on the route behind the vehicle system.

In one embodiment, in the system, at least one of the one or more reference images depicts the route without a vehicle. The control circuit detects the vehicle on the route by identifying an uninterrupted track or route in the at least one of the one or more reference images that depicts the route without the vehicle, and identifying an interruption in a corresponding track or route in the one or more rear images, the corresponding track or route being associated with the uninterrupted track or route, the interruption being indicative of the vehicle on the route. In detail, the uninterrupted track or route in the at least one reference image that depicts the route without any vehicle is identified, the interruption in the corresponding track or route in the one or more rear images is identified by identifying at least one portion of the vehicle on the route depicted in the one or more rear images compared with the uninterrupted track or route without any vehicle, and the interruption is indicative of presence or absence of the vehicle on the route based at least in part on a set percentage criteria of the vehicle as recited above. Additionally or alternatively, the interruption in the corresponding track or route in the one or more rear images is identified by identifying an unoccupied section of the route depicted in the one or more rear images compared with the uninterrupted track or route without any vehicle, and the interruption is indicative of presence or absence of the vehicle on the route based at least in part on a set percentage criteria of the route as recited above.

In one embodiment, in the system, after the vehicle on the route behind the vehicle system has been detected, the control circuit determines that the detected vehicle constitutes the auxiliary vehicle by comparing the detected vehicle to one or more auxiliary vehicle images. A storage device stores the one or more auxiliary vehicle images, while the control circuit retrieves the one or more auxiliary vehicle images from the storage device. The control circuit determines, based at least in part on the comparison, that the detected vehicle matches with a determined probability at least one of the one or more auxiliary vehicle images. Comparing the detected vehicle to one or more auxiliary vehicle images is performed by comparing the detected vehicle on the route behind the vehicle system that is depicted in the one or more rear image with at least one exemplar auxiliary vehicle that is depicted in the at least one auxiliary vehicle image while the at least one auxiliary vehicle image is, or is included in, at least one of the one or more reference images, determining a probability of likelihood of the detected vehicle from the at least one exemplar auxiliary vehicle, determining whether the probability of likelihood is larger than, equivalent to, or smaller than a set threshold value, determining that the detected vehicle matches with the determined probability the at least one exemplar auxiliary vehicle when the probability of likelihood is larger than, or equivalent to, the set threshold value, and determining that the detected vehicle does not match with the determined probability the at least one exemplar auxiliary vehicle when the probability of likelihood is smaller the set threshold value. When it determines that the detected vehicle matches the at least one exemplar auxiliary vehicle, it determines that the detected vehicle constitutes the auxiliary vehicle. When it determines that the detected vehicle does not match the at least one exemplar auxiliary vehicle, it determines that the detected vehicle constitutes the separate vehicle.

In one embodiment, in the system, after the vehicle on the route behind the vehicle system has been detected, the control circuit determines that the detected vehicle constitutes the auxiliary vehicle by determining that the detected vehicle meets with a preset schedule of the auxiliary vehicle or corresponds to a received request of attaching the auxiliary vehicle to the vehicle system. The control circuit determines that the detected vehicle meets with the preset schedule of the auxiliary vehicle or corresponds to the received request of attaching the auxiliary vehicle to the vehicle system by informing an operator of the vehicle system with a presence of the detected vehicle via a visual displaying device, an auditory playing device, a tactile presenting device, and/or a data transmitting device, and prompting the operator of the vehicle apparatus to verify that the detected vehicle meets with the preset schedule or corresponds to the received request. The operator of the vehicle system may be a personnel, or a computer, located onboard the vehicle system, or at a remote control center.

In one embodiment, in the system, after the vehicle on the route behind the vehicle system has been detected, the control circuit determines that the detected vehicle constitutes the separate vehicle by determining that the detected vehicle does not meet with a preset schedule of the auxiliary vehicle or does not correspond to a received request of attaching the auxiliary vehicle to the vehicle system. The control circuit determines that the detected vehicle does not meet with the preset schedule of the auxiliary vehicle or does not correspond to the received request of attaching the auxiliary vehicle to the vehicle system by informing an operator of the vehicle system with a presence of the detected vehicle, and prompting the operator of the vehicle apparatus to verify that the detected vehicle does not meet with the preset schedule or does not correspond to the received request. Similarly, the operator of the vehicle system may be a personnel, or a computer, located onboard the vehicle system, or at a remote control center.

In one embodiment, in the system, after the vehicle on the route behind the vehicle system has been detected, the control circuit determines that the detected vehicle constitutes the separate vehicle by comparing the one or more rear images to one or more auxiliary vehicle images. The control circuit determines, based at least in part on the comparison, that differences between the detected vehicle and the one or more auxiliary vehicle images exceed a determined difference threshold. Comparing the one or more rear images to one or more auxiliary vehicle images is performed by comparing the detected vehicle on the route behind the vehicle system that is depicted in the one or more rear image with at least one exemplar auxiliary vehicle that is depicted in at least one of the one or more auxiliary vehicle images while the at least one auxiliary vehicle image is, or is included in, at least one of the one or more reference images, determining a difference of likelihood of the detected vehicle from the at least one exemplar auxiliary vehicle, determining whether the difference of likelihood is larger than, equivalent to, or smaller than a set threshold value, determining that the detected vehicle does not match with the determined difference the at least one exemplar auxiliary vehicle when the difference of likelihood is larger than, or equivalent to, the set threshold value, and determining that the detected vehicle matches with the determined probability the at least one exemplar auxiliary vehicle when the difference of likelihood is smaller the set threshold value. When it determines that the detected vehicle does not match the at least one exemplar auxiliary vehicle, it determines that the detected vehicle constitutes the separate vehicle. When it determines that the detected vehicle matches the at least one exemplar auxiliary vehicle, it determines that the detected vehicle constitutes the auxiliary vehicle.

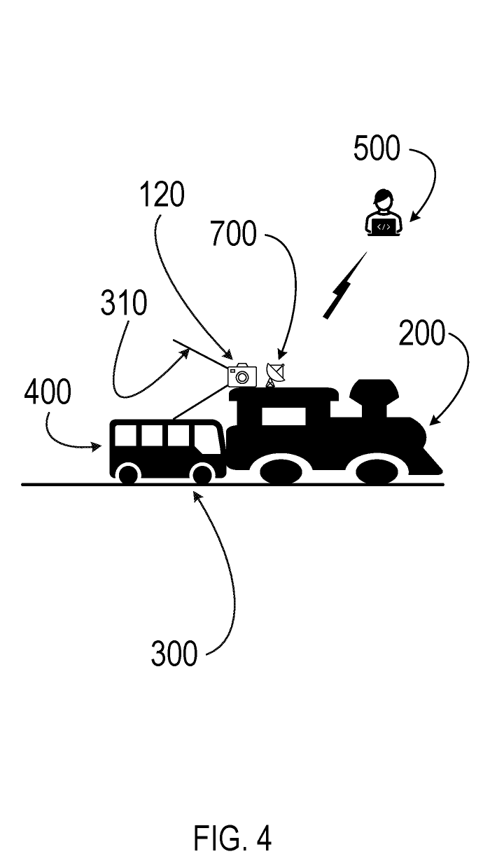

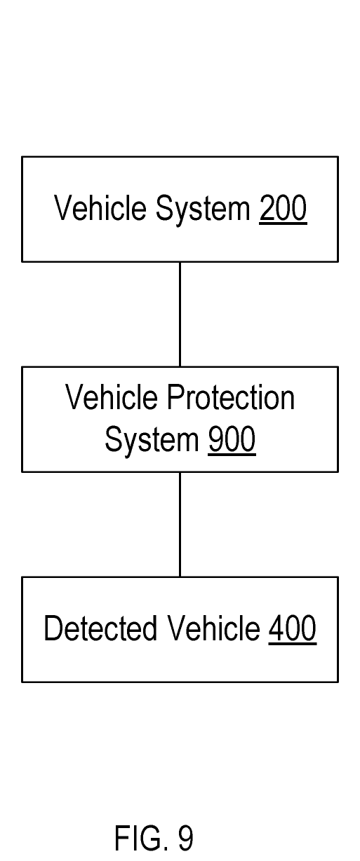

In one embodiment, in the system, the control circuit in response to a determination that the detected vehicle constitutes the auxiliary vehicle, upon an attachment of the detected vehicle to the vehicle system, as shown in FIG. 4, performs one or more of coupling a vehicle protection system, as shown in FIG. 9, with the detected vehicle in addition to the vehicle system, refraining a geographic locating device 700, as shown in FIGS. 1-2 and 4, mounted on the vehicle system from being utilized to determine a trailing edge of the vehicle system without the attachment of the detected vehicle, as shown in FIG. 2, as an overall trailing edge of the vehicle system with the attachment of the detected vehicle, as shown in FIG. 4, utilizing a geographic locating device mounted on the vehicle system to determine a trailing edge of the detected vehicle as an overall trailing edge of the vehicle system with the attachment of the detected vehicle, and/or calculating a total length of the vehicle system with the attachment of the detected vehicle by adding a length of the detected vehicle to a length of the vehicle system without the attachment of the detected vehicle.

In one embodiment, upon the attachment of the detected vehicle to the rear portion of the vehicle system, the vehicle system and the attached detected vehicle together form a modified vehicle system, as shown in FIG. 5.

In one embodiment, coupling the vehicle protection system with the detected vehicle in addition to the vehicle system renders the vehicle protection system to prevent vehicle-to-vehicle collisions, over-speed derailments, incursions into established work zones, and movements of vehicles through switches in wrong positions, for the modified vehicle system.

In one embodiment, a geographic locating device, such as a Global Positioning System (GPS) telemetry, mounted on the vehicle system is refrained from being utilized to determine a trailing edge of the vehicle system without the attachment of the detected vehicle, i.e., an unmodified vehicle system, as an overall trailing edge of the vehicle system with the attachment of the detected vehicle, i.e., the modified vehicle system. The geographic locating device is mounted on, for instance, but not limited to, the rear portion of the vehicle system.

In one embodiment, a geographic locating device mounted on the vehicle system is utilized to determine a trailing edge of the detected vehicle as an overall trailing edge of the vehicle system with the attachment of the detected vehicle, i.e., the modified vehicle system. A vehicle protection system is applied to the detected vehicle in addition to the vehicle system based at least in part on the overall trailing edge of the modified vehicle system.

In one embodiment, a total length of the vehicle system with the attachment of the detected vehicle, i.e., the modified vehicle system, is calculated by adding a length of the detected vehicle to a length of the vehicle system without the attachment of the detected vehicle, i.e., an unmodified vehicle system. A vehicle protection system is applied to the detected vehicle in addition to the vehicle system based at least in part on the total length of the modified vehicle system.

In one embodiment, in the system, the control circuit in response to a determination that the detected vehicle constitutes the separate vehicle, performs one or more of determining a risk of collision of the vehicle system with the detected vehicle, generating an alert for a risk collision of the vehicle system with the detected vehicle, and/or transmitting an alert for a risk of collision of the vehicle system with the detected vehicle to an operator of the vehicle system. The operator of the vehicle system may be a personnel, or a computer, located onboard the vehicle system, or at a remote control center.

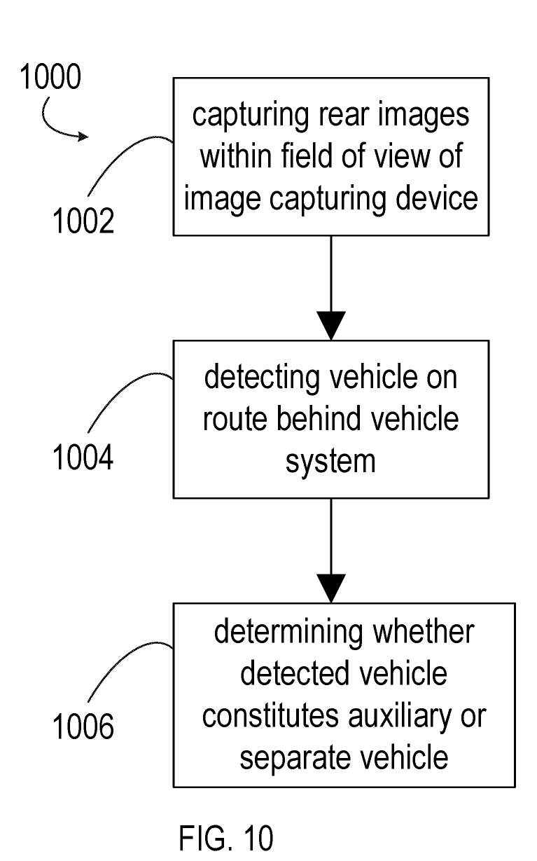

In one embodiment, a method 1000, as shown in FIG. 10 includes capturing 1002 one or more rear images within a field of view of an image capturing device. The image capturing device faces an environment behind a vehicle system. The environment includes a route traveled by the vehicle system. The method further includes based at least in part on the one or more rear images and one or more reference images, detecting 1004 a vehicle on the route behind the vehicle system, and determining 1006 whether the detected vehicle constitutes an auxiliary vehicle or a separate vehicle. In one embodiment, the method further includes determining which one of the auxiliary vehicle and the separate vehicle the detected vehicle constitutes. The method is executed in full or in part by the control circuit, as above recited.

In one embodiment, the method further includes in response to a determination that the detected vehicle constitutes the auxiliary vehicle, upon an attachment of the detected vehicle to the vehicle system, performing one or more of coupling a vehicle protection system with the detected vehicle in addition to the vehicle system, refraining a geographic locating device mounted on the vehicle system from being utilized to determine a trailing edge of the vehicle system without the attachment of the detected vehicle as an overall trailing edge of the vehicle system with the attachment of the detected vehicle, utilizing a geographic locating device mounted on the vehicle system to determine a trailing edge of the detected vehicle as an overall trailing edge of the vehicle system with the attachment of the detected vehicle, and/or calculating a total length of the vehicle system with the attachment of the detected vehicle by adding a length of the detected vehicle to a length of the vehicle system without the attachment of the detected vehicle.

In one embodiment, the method further includes in response to a determination that the detected vehicle constitutes the separate vehicle, performing one or more of determining a risk of collision of the vehicle system with the detected vehicle, generating an alert for a risk collision of the vehicle system with the detected vehicle, and/or transmitting an alert for a risk of collision of the vehicle system with the detected vehicle to an operator of the vehicle system.

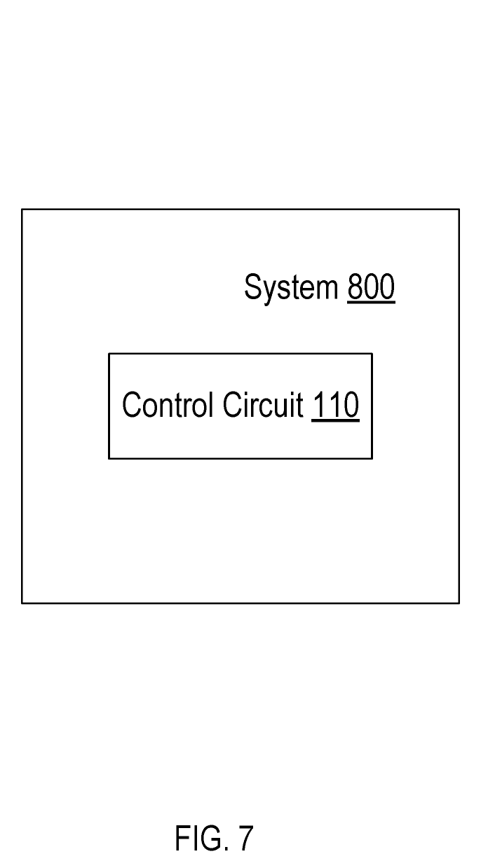

In one embodiment, a system 800, as shown in FIG. 7, includes a control circuit to capture one or more images within a field of view of an image capturing device. The control circuit may be as recited above. The image capturing device targets or faces an environment behind or recently passed by a vehicle system. The environment includes a route traveled by the vehicle system. The control circuit, based at least in part on the one or more image and one or more reference images, detects a vehicle on the route behind the vehicle system and determines whether the detected vehicle constitutes an auxiliary vehicle of the vehicle system or a separate vehicle. In one embodiment, the control circuit further determines which one of the auxiliary vehicle and the separate vehicle the detected vehicle constitutes.

In one embodiment, the control circuit, in response to a determination that the detected vehicle constitutes the auxiliary vehicle, upon an attachment of the detected vehicle to the vehicle system, couples a vehicle protection system with the detected vehicle in addition to the vehicle system, refrains a geographic locating device mounted on the vehicle system from being utilized to determine a trailing edge of the vehicle system without the attachment of the detected vehicle as an overall trailing edge of the vehicle system with the attachment of the detected vehicle, utilizes a geographic locating device mounted on the vehicle system to determine a trailing edge of the detected vehicle as an overall trailing edge of the vehicle system with the attachment of the detected vehicle, and/or calculates a total length of the vehicle system with the attachment of the detected vehicle by adding a length of the detected vehicle to a length of the vehicle system without the attachment of the detected vehicle. The control circuit, in response to a determination that the detected vehicle constitutes the separate vehicle, determines a risk of collision of the vehicle system with the detected vehicle, generates an alert for a risk collision of the vehicle system with the detected vehicle, and/or transmits an alert for a risk of collision of the vehicle system with the detected vehicle to an operator of the vehicle system.

Movement of the vehicle may include propelling the vehicle forward or backward along a direction of travel, as well as slowing or stopping the vehicle. Movement further may include turning left or right, and increasing or decreasing elevation or depth. Movement further may include determining or setting a vehicle speed, changing a vehicle speed, matching speeds between vehicles. Indirectly, movement of the vehicle may include ramping up (or down) power sources; and this may include energizing electrical circuits or buses, setting fuel flow rates, setting engine RPM rates, and the like. Each route having a top portion. In various embodiments, the top portion of the route may be a running surface, or a resting surface, for a vehicle. Groups of two or more vehicles traveling together in a coordinated manner may be referred to as a consist, swarm, fleet, convoy, fleet and the like. Embodiments may be described in connection with a rail vehicle system, or other types of vehicle systems, such as automobiles, trucks (with or without trailers), buses, marine vessels, aircraft, unmanned aircraft (e.g., drones), mining vehicles, agricultural vehicles, or other off-highway vehicles. The vehicle systems described herein (rail vehicle systems or other vehicle systems that do not travel on rails or tracks) may be formed from a single vehicle or multiple vehicles. With respect to multi-vehicle systems, the vehicles may be mechanically coupled with each other (e.g., by couplers) or logically coupled but not mechanically coupled. For example, vehicles may be logically but not mechanically coupled when the separate vehicles communicate with each other to coordinate movements of the vehicles with each other so that the vehicles travel together (e.g., as a convoy). Calculations and computations may be performed on-board the vehicle systems or off-board the vehicle systems and then communicated to the vehicle systems. An on-board or off-board vehicle control system may receive sensor inputs, operator inputs, vehicle parameters, and route parameters, etc.

The calculations and computations may be implemented in an artificial intelligence (AI) or machine-learning system. In one embodiment, a control system, a control circuit, or a controller, may have a local data collection system deployed and may use machine learning to enable derivation-based learning outcomes. The controller may learn from and make decisions on a set of data (including data provided by the various sensors), by making data-driven predictions and adapting according to the set of data. In embodiments, machine learning may involve performing a plurality of machine learning tasks by machine learning systems, such as supervised learning, unsupervised learning, and reinforcement learning. Supervised learning may include presenting a set of example inputs and desired outputs to the machine learning systems. Unsupervised learning may include the learning algorithm structuring its input by methods such as pattern detection and/or feature learning. Reinforcement learning may include the machine learning systems performing in a dynamic environment and then providing feedback about correct and incorrect decisions. Machine learning may include a plurality of other tasks based on an output of the machine learning system. The tasks may be machine learning problems such as classification, regression, clustering, density estimation, dimensionality reduction, anomaly detection, and the like. Machine learning may include a plurality of mathematical and statistical techniques. The machine learning algorithms may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). The algorithm may be used to address problems of mixed integer programming, where some components are restricted to being integer-valued. Algorithms and machine learning techniques and systems may be used in computational intelligence systems, computer vision, Natural Language Processing (NLP), recommender systems, reinforcement learning, building graphical models, and the like. Machine learning may be used for vehicle performance and control, behavior analytics, and the like.

In one embodiment, the controller may include a policy engine that may apply one or more policies. These policies may be based at least in part on characteristics of a given item of equipment or environment. With respect to control policies, a neural network can receive input of a number of environmental and task-related parameters. The neural network can be trained to generate an output based on these inputs, with the output representing an action or sequence of actions that the engine system should take. This may be useful for balancing competing constraints on the engine. During operation of one embodiment, a determination can occur by processing the inputs through the parameters of the neural network to generate a value at the output node designating that action as the desired action. This action may translate into a signal that causes the engine to operate. This may be accomplished via backpropagation, feed forward processes, closed loop feedback, or open loop feedback. Alternatively, rather than using backpropagation, the machine learning system of the controller may use evolution strategies techniques to tune various parameters of the artificial neural network. The controller may use neural network architectures with functions that may not always be solvable using backpropagation, for example functions that are non-convex. In one embodiment, the neural network has a set of parameters representing weights of its node connections. A number of copies of this network may be generated and then different adjustments to the parameters may be made, and simulations may be done. Once the output from the various models may be obtained, they may be evaluated on their performance using a determined success metric. The best model may be selected, and the vehicle controller may execute that plan to achieve the desired input data to mirror the predicted best outcome scenario. Additionally, the success metric may be a combination of the optimized outcomes. These may be weighed relative to each other.

The methods and routines disclosed herein may be stored as executable instructions in non-transitory memory and may be carried out by the control system including the controller in combination with the various sensors, actuators, and other engine hardware. The specific routines described herein may represent one or more of any number of processing strategies such as event-driven, interrupt-driven, multi-tasking, multi-threading, and the like. As such, various actions, operations, and/or functions illustrated may be performed in the sequence illustrated, in parallel, or in some cases omitted. Likewise, the order of processing is not necessarily required to achieve the features and advantages of the example embodiments described herein, but may be provided for ease of illustration and description. One or more of the illustrated actions, operations and/or functions may be repeatedly performed depending on the particular strategy being used. Further, the described actions, operations and/or functions may graphically represent code to be programmed into non-transitory memory of the computer readable storage medium in the engine control system, where the described actions may be carried out by executing the instructions in a system including the various engine hardware components in combination with the electronic controller.

As used herein, an element or step recited in the singular and proceeded with the word “a” or “an” may not exclude the plural of said elements or operations, unless such exclusion may be explicitly stated. Furthermore, references to “one embodiment” of the invention may not exclude the existence of additional embodiments that may incorporate the recited features. Moreover, unless explicitly stated to the contrary, embodiments “comprising,” “comprises,” “including,” “includes,” “having,” or “has” an element or a plurality of elements having a particular property may include additional such elements not having that property. Terms “including” and “in which” may be used as the plain-English equivalents of the respective terms “comprising” and “wherein.” Moreover, terms “first,” “second,” and “third,” etc. may be used merely as labels, and may not impose numerical requirements on their objects. Further, the limitations of the following claims may not be written in means-plus-function format and may not be intended to be interpreted based on 35 U.S.C. § 112(f), unless and until such claim limitations may expressly use the phrase “means for” followed by a statement of function devoid of further structure.

The above description may be illustrative, and not restrictive. Embodiments may not be mutually exclusive to each other. The above-described embodiments (and/or aspects thereof) may be used in combination with each other. In addition, many modifications may be made to adapt a particular situation or material to the teachings of the subject matter without departing from its scope. While the dimensions and types of materials described herein may define the parameters of the subject matter, they may be exemplary embodiments. Other embodiments may be apparent to one of ordinary skill in the art upon reviewing the above description. The scope of the subject matter may, therefore, be determined with reference to the appended claims, along with the full scope of equivalents to which such claims may be entitled.

This written description may disclose several embodiments of the subject matter, including the best mode, and may enable one of ordinary skill in the art to practice the embodiments of subject matter, including making and using any devices or systems and performing any incorporated methods. The patentable scope of the subject matter may be defined by the claims, and may include other embodiments that may occur to one of ordinary skill in the art. Such other embodiments may be intended to be within the scope of the claims if they may have structural elements that may not differ from the literal language of the claims, or if they may include equivalent structural elements with insubstantial differences from the literal languages of the claims.

A reference herein to a patent document or any other matter identified as prior art, may not to be taken as an admission that the document or other matter may be known or that the information it may contain may be part of the common general knowledge as at the priority date of any of the claims.

The foregoing description presents various embodiments of systems and processes through block diagrams, flowcharts, and examples. Each of the depicted components, functions, or operations may be implemented using hardware, software, firmware, or combinations thereof. Specific features can be executed using integrated circuits, computer programs, or processors (e.g., microprocessors, microcontrollers), as well as other software-hardware combinations. The design and development of such implementations, whether via circuitry or software, are within the technical expertise of those skilled in the art. Moreover, the described methods and mechanisms may be distributed as program products on various media, with no restriction on the format of the medium.

Instructions for implementing these features can be stored in various types of memory, including dynamic random-access memory (DRAM), flash memory, and/or cache. These instructions can also be distributed over a network or via other computer-readable media. The term "non-transitory computer-readable medium" refers to any physical medium capable of storing or transmitting instructions or information that can be read by a machine. Examples include, but are not limited to, optical disks, CD-ROMs, RAM, ROM, EPROM, EEPROM, magnetic or optical cards, flash memory, or even propagated signals such as carrier waves or infrared signals.

Software components described herein may be implemented using languages such as Python, Java, C++, or Perl. The corresponding software code may be stored on various computer-readable media, such as RAM, ROM, hard drives, or CD-ROMs. These media may be part of a single computational device or distributed across multiple devices within a networked system.

The term "control circuit" encompasses hardwired circuitry, programmable logic (such as microprocessors, microcontrollers, digital signal processors (DSPs), programmable logic devices (PLDs), programmable gate arrays (PGAs), or field-programmable gate arrays (FPGAs)), state machines, or firmware that executes stored instructions. Control circuits may form part of larger systems, such as integrated circuits (ICs), application-specific integrated circuits (ASICs), or systems -on -chips (SoCs), and are commonly found in devices such as computers, smartphones, and servers. These circuits may perform tasks involving data processing, communication, or data storage.

In some embodiments, the control circuit can utilize machine learning (ML) techniques to make decisions based on sensor inputs or other data. ML methods may include supervised learning (with labeled inputs and outputs), unsupervised learning (for identifying patterns), or reinforcement learning (where the system adapts based on feedback). Tasks for ML systems may involve classification, regression, clustering, anomaly detection, or optimization, with algorithms such as decision trees, deep learning, support vector machines (SVMs), or neural networks being employed, depending on the application.

A control circuit may also incorporate a policy engine that applies specific rules based on equipment characteristics or environmental conditions. For instance, a neural network could process sensor data or operational inputs to determine appropriate actions. Techniques such as backpropagation or evolutionary strategies may be used to refine neural network parameters and optimize model selection for the given task.

The system may handle data generation, transmission, and storage, potentially leveraging both protected and exposed data sources. Encryption and decryption can be applied during data transit, at rest, or in use, with keys and schemas determined based on operational needs. The control circuit may monitor and enforce decision boundaries, ensuring that data from protected sources meets safety or operational thresholds. If data breaches these boundaries, the system may initiate actions such as equipment shutdown, component isolation, or transitioning to safe mode to mitigate potential risks or damages.

In one embodiment, the control circuit, controller, and systems described herein may use machine learning to make determinations and to enable derivation-based learning outcomes. The system may communicate with a data collection system. The control circuit may learn from, model and make decisions/determinations on a set of data (including data provided by various sensors and data collection systems) by making data-driven predictions and adapting according to available data and modeling. Machine learning may involve performing tasks using supervised learning, unsupervised learning, and reinforcement learning systems. Supervised learning may use a set of example inputs and desired outputs to the machine learning systems, where unsupervised learning may use a learning algorithm that is structuring its input with, e.g., pattern detection and/or feature learning. Reinforcement learning may perform in a dynamic environment and then provide feedback about correct and incorrect decisions. Machine learning may include tasks based on certain outputs. These tasks may be machine learning problems such as classification, regression, clustering, density estimation, dimensionality reduction, anomaly detection, and the like to include other mathematical and statistical techniques. Suitable machine learning algorithmic types may include decision tree based learning, association rule learning, deep learning, artificial neural networks, genetic learning algorithms, inductive logic programming, support vector machines (SVMs), Bayesian network, reinforcement learning, representation learning, rule-based machine learning, sparse dictionary learning, similarity and metric learning, learning classifier systems (LCS), logistic regression, random forest, K-Means, gradient boost, K-nearest neighbors (KNN), a priori algorithms, and the like. In embodiments, certain machine learning algorithms may be used (e.g., for solving both constrained and unconstrained optimization problems that may be based on natural selection). In an example, the algorithm may be used to address problems of mixed integer programming, where some components restricted to being integer-valued. Algorithms and machine learning techniques and systems may be used in computational intelligence systems, computer vision, Natural Language Processing (NLP), recommender systems, reinforcement learning, building graphical models, and the like. In an example, machine learning may be used for making determinations, calculations, comparisons and behavior analytics, and the like.

In one embodiment, the control circuit may include a policy engine. The policies the engine may apply can be based at least in part on characteristics of a given item of equipment or environment. For example, an artificial intelligence system, such as a neural network, can receive input of a number of environmental and task-related parameters. These parameters may include, for example, operational input of the given equipment, data from various sensors, environmental information, location and/or position data, and the like. The neural network can be trained and can generate an output based on these inputs, with the output representing an action or sequence of actions that the equipment or system should take to accomplish the goal of the operation. The control circuit can process the inputs through the parameters of the neural network to generate a value (i.e., make a determination) at the output node designating that action as the desired action, activity, or operating state. An action may translate into a signal that causes the vehicle to operate in a particular manner. The control circuit may accomplish this via back-propagation, feed forward processes, closed loop feedback, or open loop feedback, for example. Alternatively, rather than using backpropagation, the control circuit may use evolution strategies techniques to tune various parameters of the neural network. The control circuit may use neural network architectures that have a set of parameters representing weights of its node connections. A number of copies of this network can be generated and adjustments to the parameters can be made with subsequent simulations. Once the outputs from the various models have been obtained, they may be evaluated on their performance using a determined success metric. The best model is selected, and the control circuit can execute that plan to achieve the desired input data to mirror the predicted best outcome scenario. Additionally, the success metric itself may be a combination of the optimized outcomes, which may be weighed relative to each other. Success metrics may be dynamically established, and the process rerun and the equipment directions further modified.

In one embodiment, data can be generated, transmitted, and stored and may involve one or both of a protected space data source and the exposed space data source. The control circuit may encrypt and decrypt data as needed at rest, during use, or in transit. Encryption keys and schema may be selected and implemented as informed by end use parameters and requirements. The control circuit may evaluate and/or identify a decision boundary (that is, a boundary that separates desired behavior from undesired behavior) with regard to that data. If the control circuit determines that some quantity of data is from a protected space data source and/or is operating within determined boundaries then the control circuit, and the equipment being controlled, may operate normally. However, if the data is determined to be from an exposed space data source and/or it crosses the decision boundary, the control circuit may respond. Suitable responses may be to power down determined equipment, signal an alert, run a diagnostic routine, perform a data backup (without overwriting existing backup data), isolate equipment (including by suspending some or all communication pathways), switch equipment or control operations to a safe mode of the control system, and/or initiate a safe mode state of the equipment (e.g., slow a vehicle to a safe and controlled stop). The safe mode may be, in one embodiment, a soft shutdown mode that it intended to avoid damage or injury based on the shutdown itself and in another embodiment may be a reboot and/or minimal reload of essential drivers and functionality.

The term "logic" refers to software, firmware, and/or circuitry configured to execute the described operations. Logic may be implemented as applications, software packages, instruction sets, or data stored on non-transitory computer-readable storage media. Firmware may be hard-coded into memory devices. Components and modules described herein may be hardware, software, or a combination thereof, and may be in active, inactive, or standby states depending on system requirements.

An "algorithm" refers to a sequence of steps designed to achieve a specific result. These steps may manipulate physical quantities, typically in the form of electrical or magnetic signals, which are represented as bits, values, symbols, or numbers. The terms used to describe these processes are labels for the underlying physical operations.

The system may operate over a packet-switched network using various communication protocols, including Ethernet (complying with IEEE 802.3 standards), X.25, frame relay, or Asynchronous Transfer Mode (ATM). Communication between devices may follow established protocols such as TCP/IP or new emerging standards.

Terms such as "processing," "computing," "calculating," or "determining" refer to operations carried out by computing systems or electronic devices, which manipulate data represented as physical (electronic) quantities within memory or registers.

Terms like "component," “system," and "module" refer to computer-related entities, whether hardware, software, or a combination thereof. One or more components may be described as "configured to," "configurable to," "operable/operative to," "adapted/adaptable to," or similar terms. Unless explicitly stated, these terms encompass components in both active and inactive states.

Unless stated otherwise, terms like "including" or "having" should be interpreted as open-ended (i.e., "including but not limited to"). Numeric claim recitations generally mean "at least" the stated number, and disjunctive terms like "A or B" should be interpreted to include either or both unless explicitly specified. Operations in any claim may generally be performed in any order unless explicitly stated. The recitation "at least one of A, B, and C" should be interpreted as any combination of A, B, and C, such A alone, B alone, C alone, A and B together, A and C together, B and C together, and/or A, B, and C together. The recitation "at least one of A, B, or C" should be interpreted to include A alone, B alone, C alone, A and B together, A and C together, B and C together, and/or A, B, and C together.

In summary, various embodiments have been described to illustrate the principles and applications of the disclosed systems and methods. These descriptions are not intended to limit the scope of the invention, and variations may be made by those skilled in the art. The accompanying claims define the invention's broadest legal scope within its spirit and scope.

What is claimed is:

1. A system, comprising:
a control circuit configured to:
capture one or more rear images within a field of view of an image capturing device, the image capturing device facing an environment behind a vehicle system, the environment including a route traveled by the vehicle system; and
based at least in part on the one or more rear image and one or more reference images:
detect a vehicle on the route behind the vehicle system; and
determine whether the detected vehicle constitutes an auxiliary vehicle or a separate vehicle.

2. The system of claim 1, wherein the image capturing device is mounted on a rear end of the vehicle system.

3. The system of claim 1, wherein at least one of the one or more reference images depict the route without a vehicle, and wherein the control circuit is further configured to:
detect the vehicle on the route by comparing the at least one of the one or more reference images that depict the route without a vehicle to the one or more rear images.

4. The system of claim 3, wherein the control circuit is configured to:
detect the vehicle on the route by further determining, based at least in part on the comparison, that differences between the at least one of the one or more reference images and the one or more rear images indicate the presence of the vehicle on the route behind the vehicle system.

5. The system of claim 1, wherein at least one of the one or more reference images depict the route without a vehicle, and wherein the control circuit is further configured to:
detect the vehicle on the route by:
identifying an uninterrupted track in the at least one of the one or more reference images that depict the route without the vehicle; and
identifying an interruption in a corresponding track in the one or more rear images, the corresponding track being associated with the uninterrupted track, the interruption being indicative of the vehicle on the route.

6. The system of claim 1, wherein the control circuit is further configured to:
determine that the detected vehicle constitutes the auxiliary vehicle by comparing the detected vehicle to one or more auxiliary vehicle images.

7. The system of claim 6, wherein the control circuit is further configured to:
determine, based at least in part on the comparison, that the detected vehicle matches with a determined probability at least one of the one or more auxiliary vehicle images.

8. The system of claim 1, wherein the control circuit is further configured to:
determine that the detected vehicle constitutes the auxiliary vehicle by determining that the detected vehicle meets with a preset schedule of the auxiliary vehicle or corresponds to a received request of attaching the auxiliary vehicle to the vehicle system.

9. The system of claim 8, wherein the control circuit is further configured to:
determine that the detected vehicle meets with the preset schedule of the auxiliary vehicle or corresponds to the received request of attaching the auxiliary vehicle to the vehicle system by:
informing an operator of the vehicle system with a presence of the detected vehicle; and
prompting the operator of the vehicle apparatus to verify that the detected vehicle meets with the preset schedule or corresponds to the received request.

10. The system of claim 1, wherein the control circuit is further configured to:
determine that the detected vehicle constitutes the separate vehicle by determining that the detected vehicle does not meet with a preset schedule of the auxiliary vehicle or does not correspond to a received request of attaching the auxiliary vehicle to the vehicle system.

11. The system of claim 10, wherein the control circuit is further configured to:
determine that the detected vehicle does not meet with the preset schedule of the auxiliary vehicle or does not correspond to the received request of attaching the auxiliary vehicle to the vehicle system by:
informing an operator of the vehicle system with a presence of the detected vehicle; and
prompting the operator of the vehicle apparatus to verify that the detected vehicle does not meet with the preset schedule or does not correspond to the received request.

12. The system of claim 1, wherein the control circuit is further configured to:
determine that the detected vehicle constitutes the separate vehicle by comparing the one or more rear images to one or more auxiliary vehicle images.

13. The system of claim 12, wherein the control circuit is further configured to:
determine, based at least in part on the comparison, that differences between the detected vehicle and the one or more auxiliary vehicle images exceed a determined difference threshold.

14. The system of claim 1, wherein the control circuit is further configured to:
in response to a determination that the detected vehicle constitutes the auxiliary vehicle, upon an attachment of the detected vehicle to the vehicle system, perform one or more of:
coupling a vehicle protection system with the detected vehicle in addition to the vehicle system;
refraining a geographic locating device mounted on the vehicle system from being utilized to determine a trailing edge of the vehicle system without the attachment of the detected vehicle as an overall trailing edge of the vehicle system with the attachment of the detected vehicle;
utilizing a geographic locating device mounted on the vehicle system to determine a trailing edge of the detected vehicle as an overall trailing edge of the vehicle system with the attachment of the detected vehicle; or
calculating a total length of the vehicle system with the attachment of the detected vehicle by adding a length of the detected vehicle to a length of the vehicle system without the attachment of the detected vehicle.

15. The system of claim 1, wherein the control circuit is further configured to:
in response to a determination that the detected vehicle constitutes the separate vehicle, perform one or more of:
determining a risk of collision of the vehicle system with the detected vehicle;
generating an alert for a risk collision of the vehicle system with the detected vehicle; or
transmitting an alert for a risk of collision of the vehicle system with the detected vehicle to an operator of the vehicle system.

16. A method, comprising:
capturing one or more rear images within a field of view of an image capturing device, the image capturing device facing an environment behind a vehicle system, the environment including a route traveled by the vehicle system; and
based at least in part on the one or more rear images and one or more reference images:
detecting a vehicle on the route behind the vehicle system; and
determining whether the detected vehicle constitutes an auxiliary vehicle or a separate vehicle.

17. The method of claim 16, further comprising:
in response to a determination that the detected vehicle constitutes the auxiliary vehicle, upon an attachment of the detected vehicle to the vehicle system, performing one or more of:
coupling a vehicle protection system with the detected vehicle in addition to the vehicle system;
refraining a geographic locating device mounted on the vehicle system from being utilized to determine a trailing edge of the vehicle system without the attachment of the detected vehicle as an overall trailing edge of the vehicle system with the attachment of the detected vehicle;
utilizing a geographic locating device mounted on the vehicle system to determine a trailing edge of the detected vehicle as an overall trailing edge of the vehicle system with the attachment of the detected vehicle; or
calculating a total length of the vehicle system with the attachment of the detected vehicle by adding a length of the detected vehicle to a length of the vehicle system without the attachment of the detected vehicle.

18. The method of claim 16, further comprising:
in response to a determination that the detected vehicle constitutes the separate vehicle, performing one or more of:
determining a risk of collision of the vehicle system with the detected vehicle;
generating an alert for a risk collision of the vehicle system with the detected vehicle; or
transmitting an alert for a risk of collision of the vehicle system with the detected vehicle to an operator of the vehicle system.

19. A system, comprising:
a control circuit configured to:
capture one or more images within a field of view of an image capturing device, the image capturing device targeting an environment recently passed by a vehicle system, the environment including a route traveled by the vehicle system; and
based at least in part on the one or more images and one or more reference images:
detect a vehicle on the route behind the vehicle system; and
determine whether the detected vehicle constitutes an auxiliary vehicle of the vehicle system or a separate vehicle.

20. The system of claim 19, wherein the control circuit is further configured to:
in response to a determination that the detected vehicle constitutes the auxiliary vehicle, upon an attachment of the detected vehicle to the vehicle system, the control circuit is further configured to:
couple a vehicle protection system with the detected vehicle in addition to the vehicle system;
refrain a geographic locating device mounted on the vehicle system from being utilized to determine a trailing edge of the vehicle system without the attachment of the detected vehicle as an overall trailing edge of the vehicle system with the attachment of the detected vehicle;
utilize a geographic locating device mounted on the vehicle system to determine a trailing edge of the detected vehicle as an overall trailing edge of the vehicle system with the attachment of the detected vehicle; or
calculate a total length of the vehicle system with the attachment of the detected vehicle by adding a length of the detected vehicle to a length of the vehicle system without the attachment of the detected vehicle; and
in response to a determination that the detected vehicle constitutes the separate vehicle, the control circuit is configured to:
determine a risk of collision of the vehicle system with the detected vehicle;
generate an alert for a risk collision of the vehicle system with the detected vehicle; or
transmit an alert for a risk of collision of the vehicle system with the detected vehicle to an operator of the vehicle system.
